(19) United States
(12) Patent Application Publication
(10) Pub. No.: US 2017/0280870 A1
(43) Pub. Date: Oct. 5, 2017

(54) Art Panel Rack

(71) Applicants: James S. Rue, Banner Elk, NC (US); Carolyn A. Crocker Rue, Banner Elk, NC (US)

(72) Inventors: James S. Rue, Banner Elk, NC (US); Carolyn A. Crocker Rue, Banner Elk, NC (US)

(21) Appl. No.: 15/088,351

(22) Filed: Apr. 1, 2016

(51) Int. Cl. A47B 81/00; B44D 3/00; A47B 47/00

(52) U.S. Cl. CPC A47B 81/00; A47B 47/00; B44D 3/00

(57) ABSTRACT

A rack for storing panels, and especially useful for drying of painted or gessoed panels, that is alternately configurable into different modes such that it can be inclined, laid flat, arranged vertically, or freestanding in the manner of an A-frame. Several best modes select dimensions that allow for components to be of similar and conveniently manufacturable dimensions and quantities of parts, to minimize costs and retain components in different positions depending upon their function during any of the alternate modes.

### FIELD OF THE INVENTION

This invention relates generally to the field of artists' materials and more specifically to a rack for drying artists' panels or canvases which have been gessoed, painted, or varnished.

### BACKGROUND OF THE INVENTION

In the production of “easel art,” artists may employ a variety of substrates upon which they paint such as wooden panels, artist board, panel board, canvas or linen mounted on stretchers or other materials (and for ease of discussion the foregoing will be collectively referred to as a “panel” or “panels”). The foregoing panels each require preparation in order for the paint (or other material) to be employed to create the work of art. For example, gesso is used to prepare panels to receive paint and artists, in order to be efficient, will often prepare multiple panels at one time. This leads to the problem of where to place all of these panels while drying occurs. In addition, artists will often paint more than one picture at a time leading to the problem of where to safely store these panels with work in progress or completed panels coated while varnish is drying.

Current practice is to place the “in process” panels around the studio in any available space such as the floor, countertops, easels, leaning against a wall or any other available location. It is self-evident that this is a less than optimal solution since the panels are exposed to damage, dust or destruction from any one of a number of causes.

It is therefore an object of the present invention to overcome the drawbacks and deficiencies of current methods of panel storage problems.

Another object of the present invention is to provide an apparatus for the safe and efficient storage of “in process” panels.

Yet another object of the present invention is to provide an apparatus for the safe and efficient storage of “in process” panels that is inexpensive.

Still another object of the present invention is to provide an apparatus for the safe and efficient storage of “in process” panels that is easy to use.

A still further object of the present invention is to provide an apparatus for the safe and efficient storage of “in process” panels that is easy to assemble disassemble, has a variety of configurations, and requires minimal storage space when not in use.

### SUMMARY OF THE INVENTION

To accomplish the foregoing objects, there is provided . . . .

### BRIEF DESCRIPTION OF THE DRAWINGS

Some of the features and advantages of the invention having been briefly described, others will appear from the detailed description which follows, when taken in connection with the accompanying drawings, in which—

FIG. 1 is a perspective view of the linear embodiment of the panel drying rack in the flat position.

FIG. 2 is a perspective view of the linear embodiment of the panel drying rack in the elevated position.

FIG. 3 is a perspective view of the linear embodiment of the panel drying rack mounted on a wall.

FIG. 4 is a perspective view of the lower end of the panel drying rack illustrating the legs extended to space the lower end of the rack away from the wall.

FIG. 5 is a plan view of the upper end of the panel drying rack illustrating the rack attached to the wall and the spacer bar.

FIG. 6 is a perspective view of the panel drying rack in the triangular configuration resting upon a flat surface.

FIG. 7 is a perspective view of the panel drying rack in the triangular configuration with the supports angled towards each other resting on a flat surface.

FIG. 8 is a perspective view of the panel drying rack in the triangular configuration with the supports angled away from each other resting on a flat surface.

### BRIEF DESCRIPTION OF THE PREFERRED EMBODIMENTS

While the present invention will be described more fully hereinafter with reference to the accompanying drawings, in which particular embodiments are shown, it is to be understood at the outset that persons skilled in the art may modify the invention herein described while still achieving the favorable results of this invention. Accordingly, the description which follows is to be understood as a broad teaching disclosure direct to person of skill in the appropriate arts and not as limiting upon the present invention.

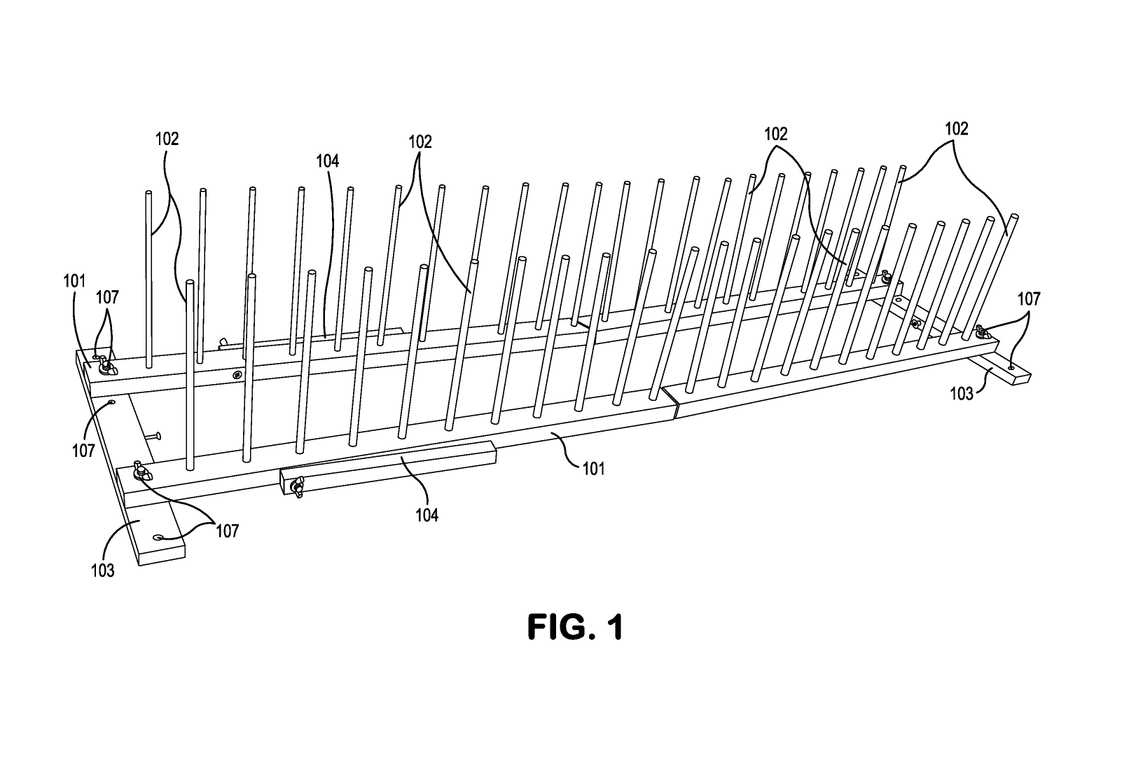

Referring now to the figures and particularly to FIG. 1, there is shown a panel drying rack laying flat on a horizontal support surface. A pair of matching elongate supports 101 extends horizontally. Sets of spindles 102 are arranged at intervals along the length of the elongate supports 101, and each set of spindles 102 extends in a direction that is substantially a large angle away from the direction of the length of the elongate supports 101. The sets of spindles 102 define panel spaces, spaces that are adapted to receive panels so that multiple panels can be supported by the rack at the same time and be separated from one another.

Adjacent the end of each elongate support, there is a spreader bar 103. The spreader bar 103 supports the elongate supports above the surface. Therefore, spreader bar 103 acts a foot. As shown, there is a spreader bar 103 at both ends of each elongate support 101 in this embodiment.

The spreader bar 103 also allows the elongate supports to connect with it at several positions along its length. Length of the spreader bar 103 extends laterally with respect to the elongate supports 101, the entire collection of positions in the lateral direction defining a range of lateral positions. As shown, the range includes preselected positions 107. Therefore, the spreader bar 103 is provides a range of lateral support positions as part of a rail mechanism. The spreader bars 103 maintain the elongate supports in spaced relation.

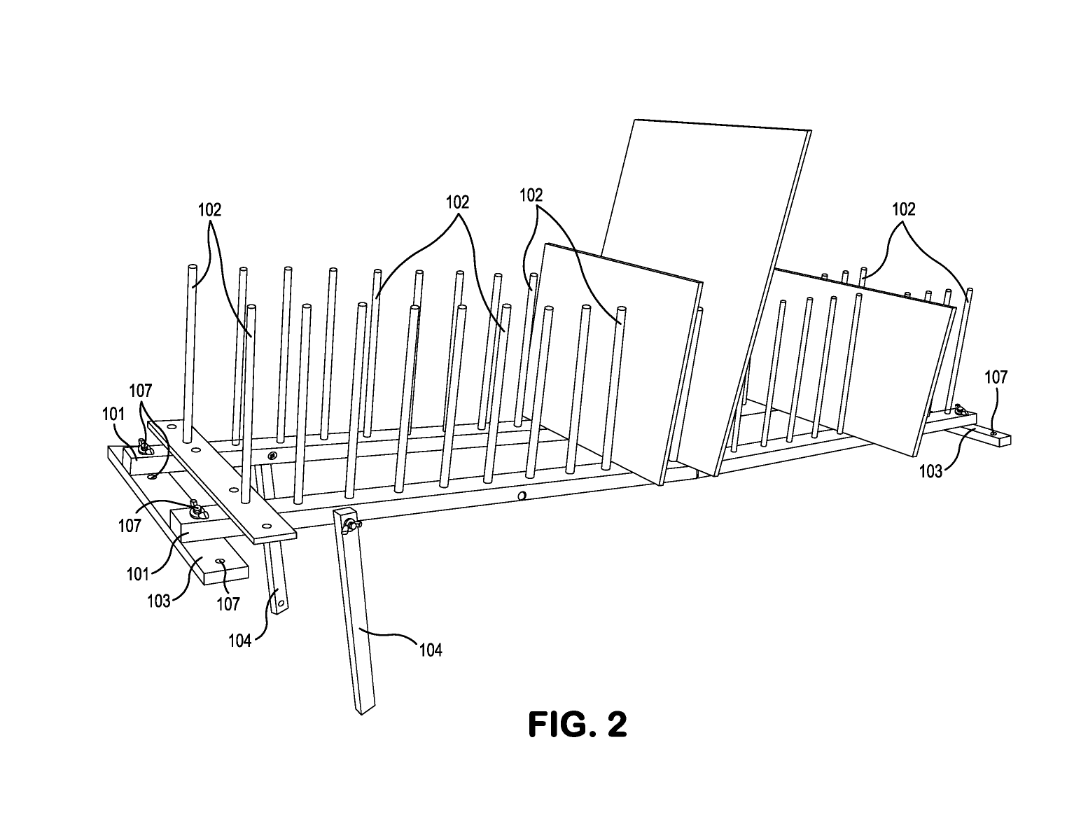

Referring now to FIG. 2, an embodiment of the panel drying rack is shown in an elevated position. It is elevated by a prop mechanism that comprises at least one leg 104. Here, two such legs 104 are shown opposite one another and extend from the elongate supports 101, each leg 104 being proximate one of the ends of at least one elongate support 101, such that the end is in an elevated position. In both FIGS. 1 and 2, the panel spaces defined by the spindles 102 extend substantially upward.

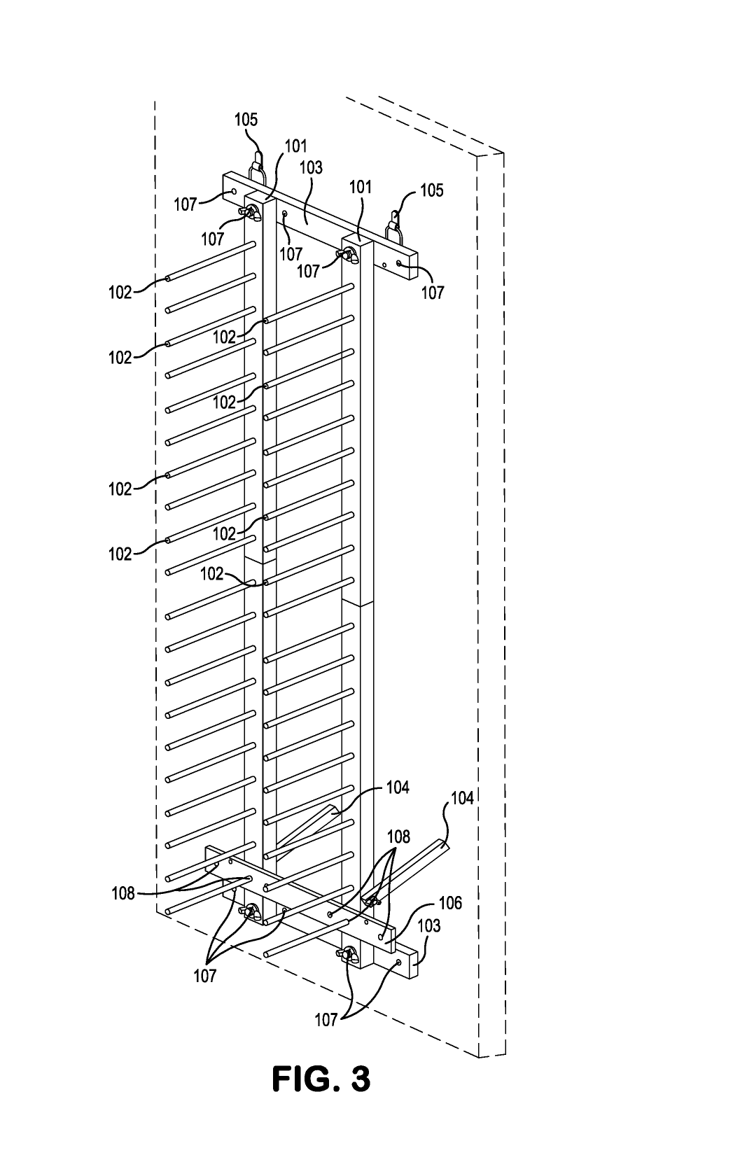

Referring now to FIG. 3, there is shown the panel drying rack mounted on a wall. A connector 105 is located proximate to the end of each elongate support 101 that is opposite the ends of the elongate supports 101 to which each leg 104 is proximate. The connectors 105 allow the system to maintain its linear configuration while mounted in a vertical direction to a wall. While the linear configurations of the system shown in FIGS. 1 and 2 arrange the elongate supports 101 at respectively zero and small angles with respect to the horizontal surface, with the panel spaces oriented substantially vertically, the linear configuration of the system shown in FIG. 3 is substantially vertical, a very high angle with respect to a horizontal surface. In FIG. 3, with the elongate supports 101 extending vertically, the sets of spindles 102 extend substantially horizontally, and therefore the panel spaces between the spindles 102 have a panel support plane, extending substantially horizontally, and can retain panels in a substantially horizontal orientation.

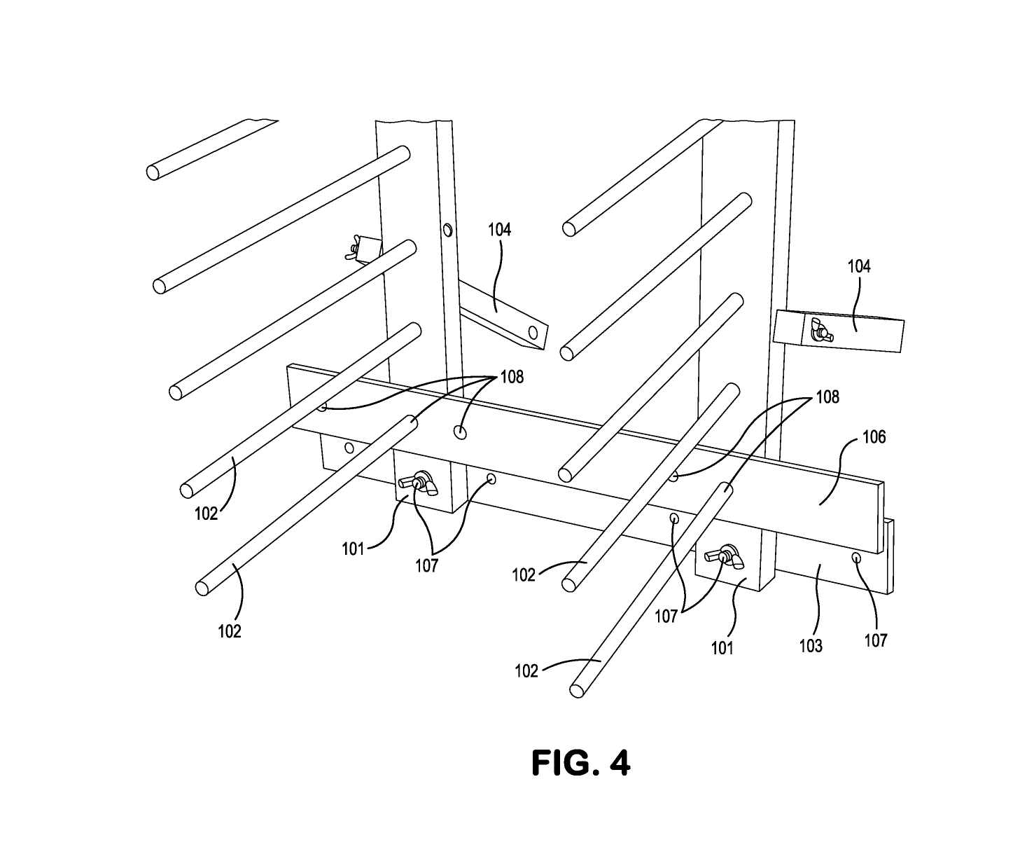

Referring now to FIG. 4, there is shown the lower end of the panel drying rack as mounted to a wall, but with each leg 104 extended, spacing the lower end of the system away from the wall. In this embodiment, the legs 104 form a prop mechanism that spaces. As in FIG. 2, each leg 104 plays the role of providing a space between a supporting surface and one end of the elongate rails 101. Here, mounted to a wall by hanging on the connectors 105, the panel spaces remain only at a small angle of inclination with respect to horizontal, and the panels near the ends of the elongate supports 101 are each proximate to a leg 104 are offset from the wall by the space provided by the legs forming a prop mechanism.

By contrast, when elevated from a horizontal surface by a leg 104 (as in FIG. 2), the elongate supports 101 are maintained at a small angle with respect to the floor, and the panels are instead retained at a high angle of inclination. Generally, panels are most efficient to dry when they are held in a substantially horizontal angle, thereby making mounting the system to a wall particularly good for drying panels. While less efficient for drying than vertical mounting, laying the elongate supports 101 horizontally, and thereby retaining panels vertically, still facilitates improved drying, because it provides spaces between adjacent panels.

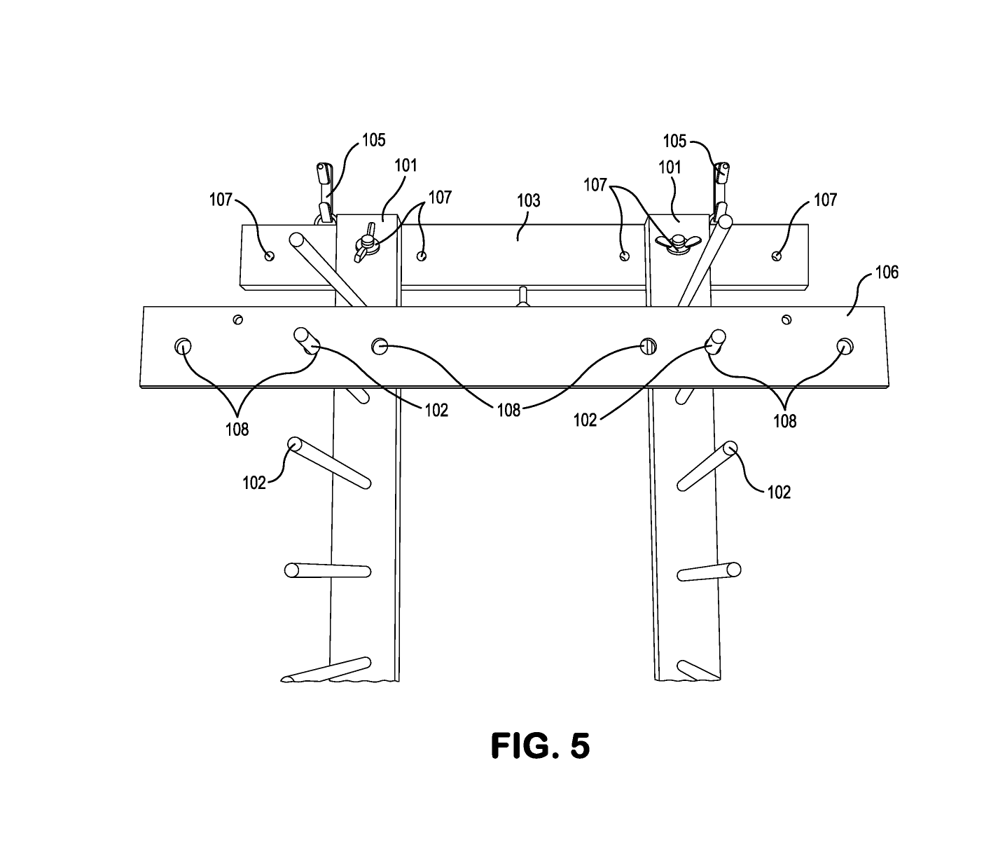

Referring to FIG. 5, there is shown a front elevation view of the upper end of the system when it is mounted on a wall. The top ends of the elongate supports 101 connect with the spreader bar 103 at the ends which are each proximate to a connector 105, and extend downward therefrom in substantially offset relation as rails, similar to FIGS. 1 and 2. Also in view are the top few sets of spindles 102. The spreader bar 103 shown has several preselected lateral positions along its length, and the elongate supports 101 are each connected thereto at two of the preselected lateral positions. Disposed on a set of spindles 102 is a spacer bar 106.

The spacer bar 106 comprises several preselected positions 108 which are provided as a similar distance range to the lateral distance range over which the several preselected lateral positions 107 appear on the spreader bar 103. The similarity is such that the spacer bar can be located with respect to the the elongate supports 101 across a variety of distances at which the spindles 102 of a set of spindles 102 may be spaced, according to the elongate supports 101 being rails offset from one another in a rail mechanism.

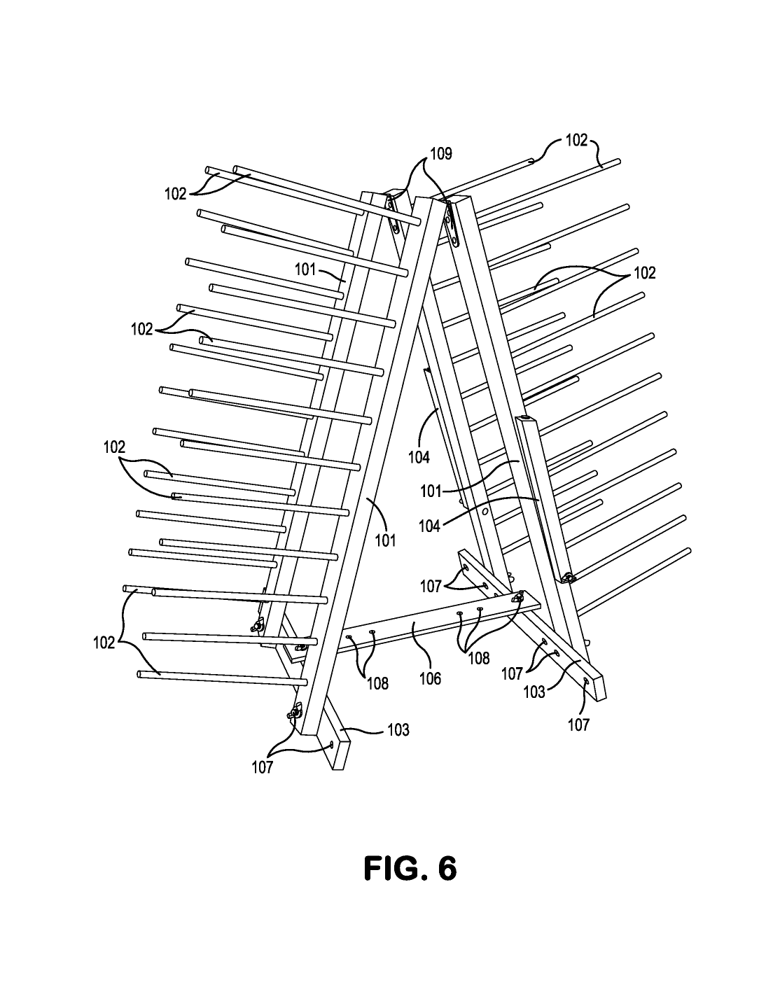

Referring to FIG. 6, what is shown is a panel drying rack in a triangular configuration resting upon a flat surface. In this arrangement, the elongate supports 101 are able to articulate about their centers in order to form a shape which allows for the rack to have opposing sides, with sets of spindles 102 extending outwardly away from each respective side. Here, the articulation is achieved by a hinge 109. The elongate supports 101 obtain a high angle of inclination with respect to the ground, and the sets of spindles 102 commensurately are at a relatively small angle of inclination with respect to vertical. However, because this triangular configuration never arranges the elongate supports 101 in a fully vertical position, the sets of spindles 102 are never parallel to the ground, each extending outwardly in opposite directions, at least some small angle upward.

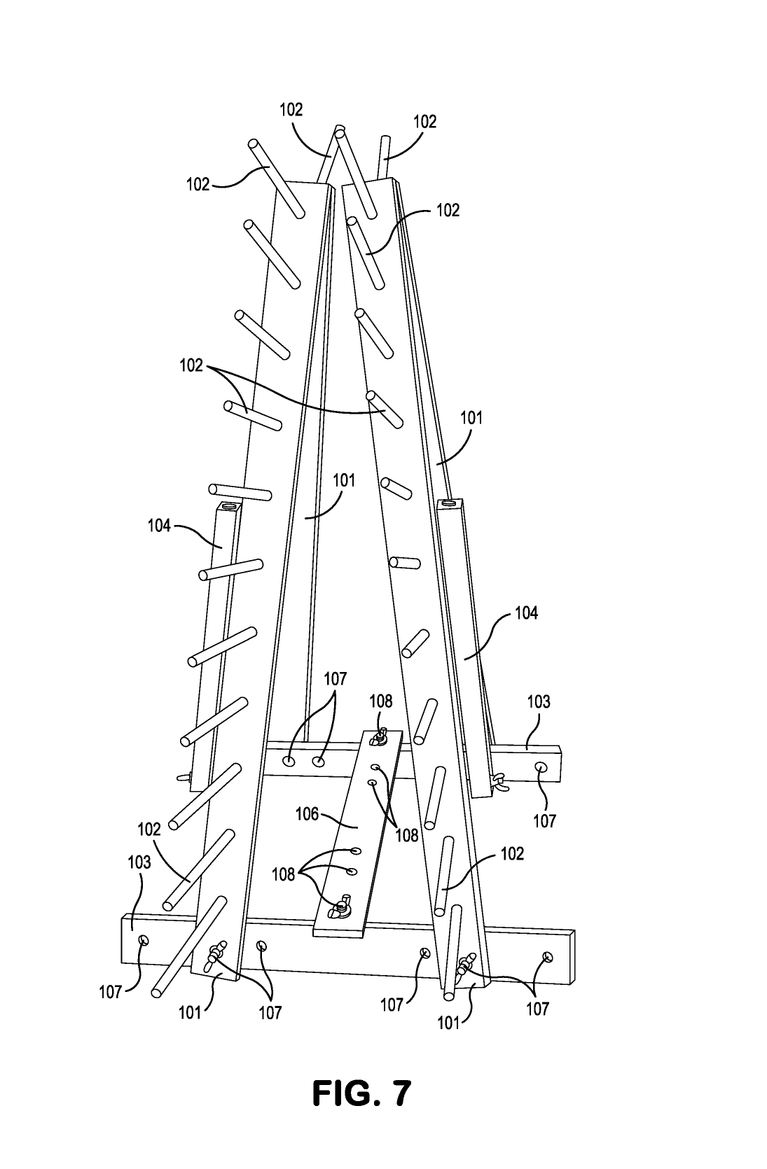

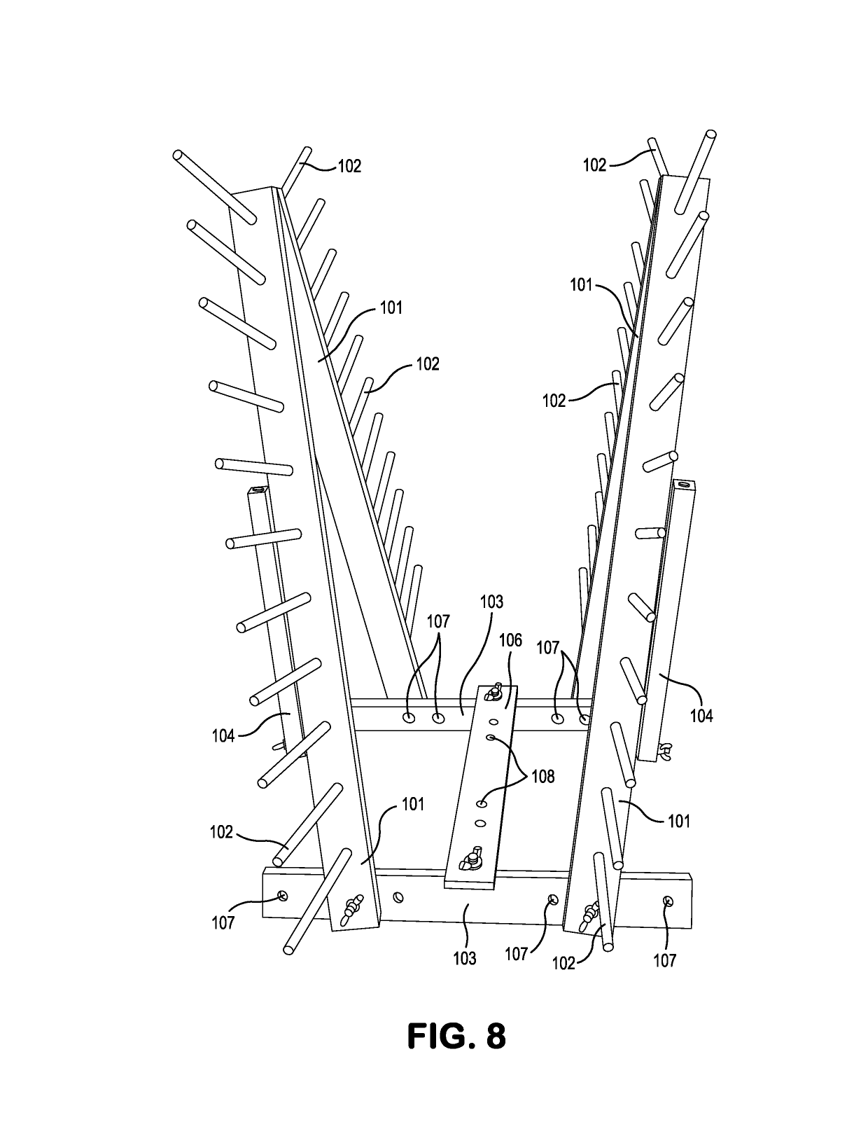

Referring now to FIGS. 7 and 8, there are shown racks in the triangular configuration that is similar to FIG. 6, but each elongate support 101 is pivotably connected with the spacer bar 103, such that the distance between the elongate supports 101 may be increased or decreased by inclining the elongate supports with respect to one another. In both of FIGS. 7 and 8, the ability of the elongate supports 101 to be located laterally at any of many positions is not impeded by being able to pivot with respect to the spacer bar 103.

In FIG. 7, the elongate supports 101 are inclined toward one another. The distance between the spindles 102 of the set near the top ends of each elongate support 101 is therefore smaller than the spindles 102 of the set at the bottom of the supports 101, such that a smaller painting can be supported. In FIG. 8, the supports 101 are inclined away from one another. The distance between the spindles 102 of the set near the top ends of each elongate support 101 is therefore larger than that of the spindles 102 of the set at the bottom of the supports 101, such that a larger panel can be supported.

Referring back to FIGS. 6-8, the spacer bar 106 extends between the spreader bars 103, to hold them at a lateral distance. The spacer bar 106 comprises several preselected positions at which to engage either spreader bar 106, and thereby maintained the bars at a variety of distances of offset. If the distance of offset is small, the angle of inclination of the elongate supports 101 is high, and brings the angle of inclination of the panel spaces progressively closer to horizontal, which is better for drying. When the distance of offset is large, then the angle of inclination of the elongate supports 101 with respect to the ground is not quite as high, and the panels are at an angle of inclination that is further from horizontal, which affords some greater degree of stability, in terms of retaining panels further into the panel spaces so that they are less likely to be nudged off of a set of spindles 102.

That which is claimed is:

1. A system for storing panels comprising:
a pair of matching elongate supports, each of said elongate supports including a plurality of spaced apart spindles secured to and extending substantially perpendicularly there from and further, said elongate supports being constructed and arranged to be interconnected and when interconnected, said spindles on each of said respective supports are spaced to be positioned opposite one another
a spreader bar adapted to be connected at the same location between the respective elongate supports to maintain said elongate supports in spaced relation.

2. The system for storing panels according to claim 1, wherein said spreader bar is adapted to be connected proximate one of the ends of the respective elongate supports.

3. The system for storing panels according to claim 2, further including a second spreader bar adapted to be connected proximate the opposite ends of the respective elongate supports.

4. The system for storing panels according to claim 1, wherein said each of said elongate supports includes a leg positioned proximate an end of said elongate support, constructed and arranged to be extended relative therefrom, said legs being located opposite one another, comprising a type of extension selected from a list comprising pivotal extension,
whereby extension of the legs allows the storage system to be positioned at an angle, on a flat surface.

5. The system for storing panels according to claim 3, wherein each elongate support includes a hinge at its center, so that it may articulate to form an “A” shape, and wherein the respective ends of said support are laterally spaced from one another with a spacer bar constructed and arranged to be interconnected between said spreader bars, whereby said spindles extend from both sides of the system to allow panels to be supported on both sides.

6. The system for storing panels according to claim 5, wherein the connection between said elongate supports and said spreader bars is constructed and arranged for pivotal movement so that said elongate supports may be positioned to be angled towards or away from each other,
whereby the system can accommodate panels of varying size.

7. The system for storing panels according to claim 3 wherein each of said elongate supports further includes a connector positioned proximate one end so that the system can be secured to a wall.

8. The system for storing panels according to claim 7, wherein legs are attached to said elongate supports at an end that is opposite said connectors and are adapted to be extended to maintain that end in spaced relation from the wall so that when panels are placed on the spindles, the panels are urged towards the wall to prevent the panels from sliding off the rack, comprising a type of extension selected from a list comprising pivotal extension

9. The system for storing panels according to claim 1, wherein said spreader bar is constructed and arranged so that the distance between respective elongate supports is adjustable,
whereby the rack can hold panels of varying sizes.

10. The system for storing panels according to claim 1, wherein said spreader bar is constructed and arranged so that said elongate supports are interconnectable at a plurality of preselected distances.

11. A system for storing panels, adapted to be supported with respect to a supporting surface, comprising at least one elongate support, the system being adapted to be arranged into plural alternative modes, including modes which orient said at least one elongate support at a non-parallel angle to a supporting surface, further comprising a plurality of spindle sets that are located at intervals along the length of said at least one elongate support, and wherein the spindle sets define panel spaces between adjacent spindle sets, each of said panel spaces being adapted to receive and support panels by defining a panel support plane, the panel support plane arranged at a large angle with respect to the direction of the length of said at least one elongate support.

12. The system of claim 11, and further comprising a prop mechanism, a prop mechanism being one which increases the distance between one end of said at least one elongate support and a support surface, that increased distance being a space that is a relatively large offset, relative to the distance between the opposite end of said at least one elongate support and said support surface.

13. The system of claim 11, wherein the system has two sides, each side provided at least a part of the length of said at least one elongate support, the spindle sets extending outward from each side, each side being at some angle offset from both a purely vertical or horizontal support surface

14. The system of claim 11, further comprising a rail mechanism with a lateral foot, wherein said at least one elongate support is a laterally inconnectable rail with respect to another at least one elongate support, the foot extending in a lateral direction with respect to the length of said at least one elongate support, comprising a range of rail positions along its length, at which said at least one elongate support may be connected at a distance offset from said another at least one elongate support.

15. The system of claim 11, wherein said at least one elongate support comprises a rail mechanism that comprises at least one rail that is pivotably inclinable in a direction that is the same plane as the length of said at least one elongate support.

16. The system of claim 11, wherein said system is also adapted to at least one mode of operation in which said at least one elongate support is configured to extend purely linearly from end-to-end, along its length.

17. The system of claim 12, wherein the support surface is a surface that is approximately horizontal.

18. The system of claim 12, further comprising a connector proximate to said opposite end.

19. The system of claim 13, wherein said at least one elongate support is pivotable about a central position along its length, such that the ends of said at least one elongate support is horizontally offset from with respect to the other, and further includes a spacer bar that provides a range of distances at which said ends can be horizontally offset.

20. The system of claim 18, wherein said connector supports the system vertically with respect to a vertical support surface.
